(19) United States
(12) Patent Application Publication
(10) Pub. No.: US 2012/0278377 A1
(43) Pub. Date: Nov. 1, 2012

(54) SYSTEM AND METHOD FOR DETERMINING DEVICE COMPLIANCE AND RECRUITMENT

(75) Inventors: Nancy Weissman, Reisterstown, MD (US); Mary Penn, Columbia, MD (US); Adam Gluck, Dundalk, MD (US); Alan Neuhauser, Silver Spring, MD (US); Jack Crystal, Owings Mills, MD (US)

(73) Assignee: ARBITRON, INC., Columbia, MD (US)

(21) Appl. No.: 13/341,113

(22) Filed: Dec. 30, 2011

Related U.S. Application Data
(63) Continuation-in-part of application No. 11/776,940, filed on Jul. 12, 2007.
(60) Provisional application No. 60/831,744, filed on Jul. 12, 2006.

(51) Int. Cl. G06F 15/16

(52) U.S. Cl. 709/201

(57) ABSTRACT

Systems and methods are disclosed for processing data provided by portable user appliances (PUAs) that are configured to provide research data that includes media exposure data. Each of the PUAs include a detector or sensor that reports a configuration and/or usage of the PUA. The configuration and/or usage is processed to determine if the PUA is in compliance with a predetermined usage criteria. Under one example, each panelist is equipped with a plurality of PUAs such as smart phones, computers or other devices, and compliance is measured for each panelist across the plurality of PUAs while research data is collected.

### RELATED APPLICATIONS

The present application is a continuation-in-part of nonprovisional U.S. patent application Ser. No. 11/776,940, filed Jul. 12, 2007 to Neuhauser et al. titled “Method and Systems for Compliance Confirmation and Incentives,” which claims priority to provisional U.S. Patent Application No. 60/831,744, filed on Jul. 12, 2006, all of which are assigned to the assignee of the present application and are incorporated by reference in their entirety herein.

### TECHNICAL FIELD

Methods and systems for monitoring use of research devices by users are disclosed. Systems and methods are disclosed that are useful for monitoring use of research devices, including on-device and around-device characteristics, to determine compliance in accordance with predetermined criteria. Additional recruitment and incentive-based processes may then be utilized to improve the collection of media data exposure from panelists.

### BACKGROUND INFORMATION

Research operations are conducted by establishing a panel of participants often referred to as panelists. In some research operations, the panelists are provided with portable monitoring devices or computing devices to gather research data. In other research operations the panelists' own portable devices are employed to gather research data. In either case, the panelists are instructed to carry the portable devices with them during the day for gathering research data, such as data indicating exposure to media and/or other market research data.

Those who pay to use such market research data want to be assured that the data is reliable. In particular, if the portable monitor was not actually carried about by a panelist during the day, whatever data has been collected by the portable monitor does not reflect the experience of a panelist. Accordingly, those who pay for use of such research data want reasonable assurances from the research organization that the portable monitors used to gather the data have actually been carried about by individuals or at least accompany individuals during the times that research data is collected by such monitors.

Arbitron Inc., which pioneered the use of portable monitors for gathering research data, has developed and implemented techniques to provide such assurances to those who license its research data. Such techniques are the subject of U.S. Pat. No. 5,483,276 issued Jan. 9, 1996 in the names of Brooks, et al., which is owned by the assignee of the present application and is hereby incorporated herein by reference in its entirety. In recent developments, cellular phones, laptops, tablet computers and similar computing devices have been configured to provide research data as well, where the research data is not only limited to received audio, but to computer-related areas as well, such as web usage, digital media usage and the like. As this research data grows in complexity, there is a need to determine compliance among multiple devices, and determining whether specific panelists are “intab.” As referred to herein, “intab” refers to data deemed acceptable for use in reports because the panelist has adhered sufficiently to the prescribed compliance requirements. By identifying panelists that are intab versus those that are not, adjustments to compliance and/or recruitment may be accomplished.

### BRIEF SUMMARY

In one exemplary embodiment, a computer-implemented method is disclosed for determining usage of a plurality of portable user appliances (PUAs), configured to detect media exposure, wherein each of the PUAs are equipped with respective detectors, the method comprising the steps of: receiving PUA data from each of a plurality of detectors; receiving research data from each of the PUAs, wherein the research data comprises media exposure data; associating the research data with the PUA data; and processing the PUA data to determine if each of the PUAs are in compliance with a predetermined usage criteria.

In another exemplary embodiment, a system is disclosed for determining usage of a plurality of portable user appliances (PUAs), comprising: a first input for receiving PUA data detected from each of the PUAs; a second input for receiving research data from each of the PUAs, wherein the research data comprises media exposure data; and a processor, operatively coupled to the first and second input, wherein the processor associates the research data with the PUA data, and wherein the processor processes the PUA data to determine if each of the PUAs are in compliance with a predetermined usage criteria.

### BRIEF DESCRIPTION OF THE DRAWINGS

The present invention is illustrated by way of example and not limitation in the figures of the accompanying drawings, in which like references indicate similar elements and in which:

FIG. 1A illustrates various monitoring systems that include a portable user appliance (“PUA”) used by a user and configured to operate as a research device;

FIG. 1B is a block diagram showing certain details of the monitoring systems of FIG. 1A;

FIG. 1C is a block diagram showing the monitoring systems of FIG. 1A including a PUA coupled with a docking station;

FIGS. 2A and 2B are flow diagrams illustrating actions by the monitoring systems of FIGS. 1A-1C which passively monitor use of the PUA;

FIG. 3 is a flow diagram illustrating actions by the monitoring systems of FIGS. 1A-1C which actively and passively monitor use of the PUA;

FIG. 4 is a block diagram of a cellular telephone configured to operate as a research device;

FIG. 4A is a functional block diagram for use in explaining certain embodiments involving the use of the cellular telephone of FIG. 4; and

FIG. 6 illustrates an embodiment for providing contextual information relating to media data exposure.

### DETAILED DESCRIPTION

Numerous types of research operations carried out with the use of research devices are possible, including, without limitation, television and radio program audience measurement; exposure to advertising in various media, such as television, radio, print and outdoor advertising, among others; consumer spending habits; consumer shopping habits including the particular retail stores and other locations visited during shopping and recreational activities; travel patterns, such as the particular routes taken between home and work, and other locations; consumer attitudes, beliefs, awareness and preferences; and so on. For the desired type of media and/or market research operation to be conducted, particular activity of individuals is monitored. In research operations research data relating to two or more of the foregoing are gathered, while in others only one kind of such data is gathered.

Various monitoring techniques are suitable. For example, television viewing or radio listening habits, including exposure to commercials therein, are monitored utilizing a variety of techniques. In certain techniques, acoustic energy to which an individual is exposed is monitored to produce data which identifies or characterizes a program, song, station, channel, commercial, etc. that is being watched or listened to by the individual. Where audio media includes ancillary codes that provide such information, suitable decoding techniques are employed to detect the encoded information, such as those disclosed in U.S. Pat. No. 5,450,490 and U.S. Pat. No. 5,764,763 to Jensen, et al., U.S. Pat. No. 5,579,124 to Aijala, et al., U.S. Pat. Nos. 5,574,962, 5,581,800 and 5,787,334 to Fardeau, et al., U.S. Pat. No. 6,871,180 to Neuhauser, et al., U.S. Pat. No. 6,862,355 to Kolessar, et al. issued Mar. 1, 2005 and U.S. Pat. No. 6,845,360 to Jensen, et al., issued Jan. 18, 2005, each of which is assigned to the assignee of the present application and all of which are incorporated herein by reference in their entireties.

Still other suitable decoding techniques are the subject of PCT Publication WO 00/04662 to Srinivasan, U.S. Pat. No. 5,319,735 to Preuss, et al., U.S. Pat. No. 6,175,627 to Petrovich, et al., U.S. Pat. No. 5,828,325 to Wolosewicz, et al., U.S. Pat. No. 6,154,484 to Lee et al., U.S. Pat. No. 5,945,932 to Smith, et al., PCT Publication WO 99/59275 to Lu, et al., PCT Publication WO 98/26529 to Lu, et al., and PCT Publication WO 96/27264 to Lu, et al., U.S. Pat. No. 7,006,555 to Srinivasan, U.S. Pat. No. 6,968,564 to Srinivasan, PCT publication WO 05/99385 to Ramaswamy, et al., U.S. Pat. No. 6,879,652 to Srinivasan, U.S. Pat. No. 6,621,881 to Srinivasan and U.S. Pat. No. 6,807,230 to Srinivasan all of which are incorporated herein by reference in their entireties.

In some cases a signature is extracted from transduced media data for identification by matching with reference signatures of known media data. Suitable techniques for this purpose include those disclosed in U.S. Pat. No. 5,612,729 to Ellis, et al. and in U.S. Pat. No. 4,739,398 to Thomas, et al., each of which is assigned to the assignee of the present application and both of which are incorporated herein by reference in their entireties.

Still other suitable techniques are the subject of U.S. Pat. No. 2,662,168 to Scherbatskoy, U.S. Pat. No. 3,919,479 to Moon, et al., U.S. Pat. No. 4,697,209 to Kiewit, et al., U.S. Pat. No. 4,677,466 to Lert, et al., U.S. Pat. No. 5,512,933 to Wheatley, et al., U.S. Pat. No. 4,955,070 to Welsh, et al., U.S. Pat. No. 4,918,730 to Schulze, U.S. Pat. No. 4,843,562 to Kenyon, et al., U.S. Pat. No. 4,450,551 to Kenyon, et al., U.S. Pat. No. 4,230,990 to Lert, et al., U.S. Pat. No. 5,594,934 to Lu, et al., European Published Patent Application EP 0887958 to Bichsel and PCT publication No. WO 91/11062 to Young, et al., PCT Publication WO 05/006768 to Lee, et al., PCT Publication No. WO 06/023770 to Srinivasan, and PCT Publication No. WO 05/046201 to Lee, all of which are incorporated herein by reference in their entireties.

One advantageous technique carries out either or both of code detection and signature extraction remotely from the location where the research data is gathered, as disclosed in US Published Patent Application 2003/0005430 published Jan. 2, 2003 to Ronald S. Kolessar, which is assigned to the assignee of the present application and is hereby incorporated herein by reference in its entirety.

If location tracking or exposure to outdoor advertising is carried out, then various techniques for doing so are employed. Suitable techniques for location tracking or monitoring exposure to outdoor advertising are disclosed in U.S. Pat. No. 6,958,710 in the names of Jack K. Zhang, Jack C. Crystal, and James M. Jensen, issued Oct. 25, 2005, and US Published Patent Application 2005/0035857 A1 published Feb. 17, 2005 in the names of Jack K. Zhang, Jack C. Crystal, James M. Jensen and Eugene L. Flanagan III, filed Aug. 13, 2003, all of which are assigned to the assignee of the present application and hereby incorporated by reference herein in their entireties.

Where usage of publications, such as periodicals, books, and magazines, is monitored, suitable techniques for doing so are employed, such as those disclosed in U.S. patent application Ser. No. 11/084,481 in the names of James M. Jensen, Jack C. Crystal, Alan R. Neuhauser, Jack Zhang, Daniel W. Pugh, Douglas J. Visnius, and Eugene L. Flanagan III, filed Mar. 18, 2005, which is assigned to the assignee of the present application and hereby incorporated by reference herein in its entirety.

In addition to those types of research data mentioned above and the various techniques identified for gathering such types of data, other types of research data may be gathered and other types of techniques may be employed. For example, research data relating to consumer purchasing conduct, consumer product return conduct, exposure of consumers to products and presence and/or proximity to commercial establishments may be gathered, and various techniques for doing so may be employed. Suitable techniques for gathering data concerning presence and/or proximity to commercial establishments are disclosed in US Published Patent Application 2005/0200476 A1 published Sep. 15, 2005 in the names of David Patrick Forr, James M. Jensen, and Eugene L. Flanagan III, filed Mar. 15, 2004, and in US Published Patent Application 2005/0243784 A1 published Nov. 3, 2005 in the names of Joan Fitzgerald, Jack Crystal, Alan Neuhauser, James M. Jensen, David Patrick Forr, and Eugene L. Flanagan III, filed Mar. 29, 2005. Suitable techniques for gathering data concerning exposure of consumers to products are disclosed in US Published Patent Application 2005/0203798 A1 published Sep. 15, 2005 in the names of James M. Jensen and Eugene L. Flanagan III, filed Mar. 15, 2004.

Moreover, techniques involving the active participation of the panel members may be used in research operations. For example, surveys may be employed where a panel member is asked questions utilizing the panel member's research device after recruitment. Thus, it is to be understood that both the exemplary types of research data to be gathered discussed herein and the exemplary manners of gathering research data as discussed herein are only illustrative and that other types of research data may be gathered and that other techniques for gathering research data may be employed.

Certain research devices, including many disclosed in the patents and applications incorporated herein by reference, are intended solely for use in conducting research operations and do not implement functions of primary benefit to the user. Other research devices are implemented by, in or in combination with a PUA.

Various PUA's already have capabilities sufficient to enable the implementation of the desired monitoring technique or techniques to be employed during the research operation to enable their use as research devices. As an example, cellular telephones, laptops, and tablet computers have microphones which convert acoustic energy into audio data and GPS receivers for determining their locations. Various cellular telephones, laptops, and tablet computers further have processing and storage capabilities. In certain embodiments, various existing PUA's are modified merely by software and/or minor hardware changes to carry out a research operation. In certain other embodiments, PUA's are redesigned and substantially reconstructed for this purpose.

In certain embodiments, the research device itself is operative to gather research data. In certain embodiments, the research device emits data that causes another device to gather research data. Such embodiments include various embodiments disclosed in U.S. Pat. No. 6,958,710 and in U.S. patent application Ser. No. 11/084,481, referenced above, as well as U.S. provisional patent application No. 60/751,825 filed Dec. 20, 2005 assigned to the assignee of the present application and hereby incorporated herein by reference in its entirety. In certain embodiments, the research device is operative both to gather research data and to emit data that causes another device to gather research data.

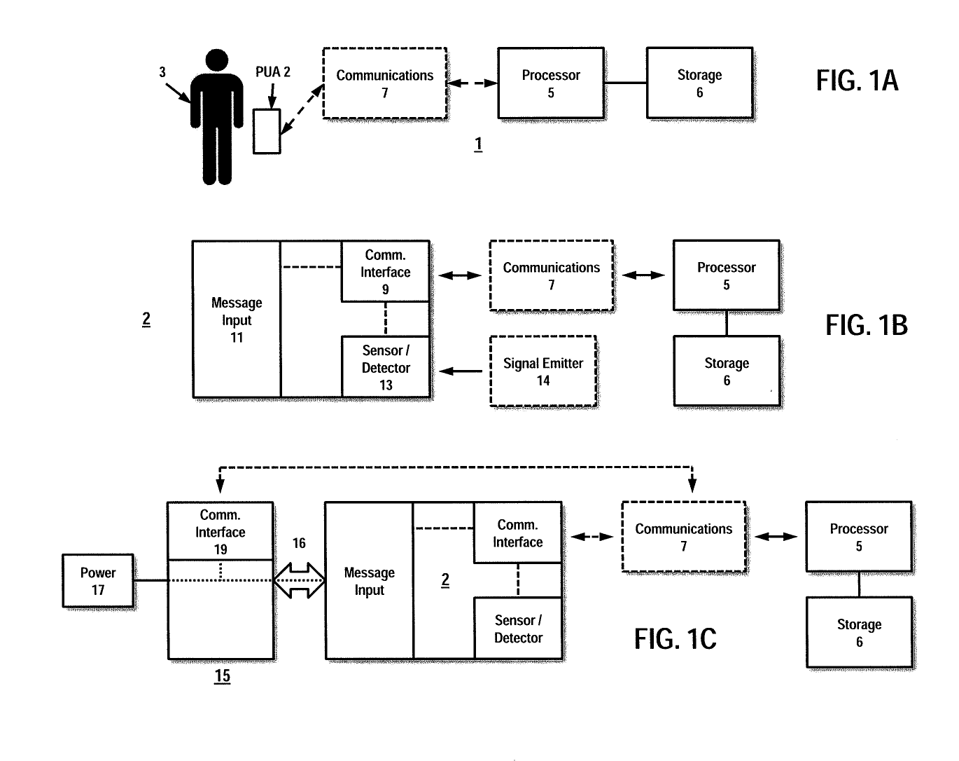

Various embodiments of methods and systems for monitoring use of a research device by one or more users are described herein below. Referring to the drawings, FIGS. 1A and 1B are schematic illustrations of a monitoring system 1 that includes a PUA 2, which is used by a panelist or user 3, and a processor 5. PUA 2 may be embodied as a cell phone, a personal computer (PC), a laptop, a tablet computer, and the like. In certain embodiments otherwise corresponding to the embodiment of FIGS. 1A and 1B, the PUA 2 is replaced by a research device that does not comprise a PUA. The processor 5 may include one or a plurality of processors which are located together or separate from one another disposed within or controlled by one or more organizations. As shown, the PUA 2 may be coupled to the processor 5 via communications 7 which allows data to be exchanged between the PUA 2 and the processor 5. In certain embodiments, the PUA 2 is wirelessly coupled via communications 7 to the processor 5. In some embodiments, the monitoring system 1 also includes storage 6 for storing data including, but not limited to, data received and/or processed by the central processor 5. In certain embodiments storage 6 includes one or more storage units located together or separate from one another at the same or different locations. In certain embodiments storage 6 is included with processor 5.

FIG. 1B is a more detailed illustration of an embodiment of the monitoring system 1 in which the PUA 2 is adapted to communicate wirelessly with the processor 5 using wireless communications 8. The PUA 2 includes a communication interface 9 for communicating and receiving data through communications 8. As shown, the PUA 2 also includes a message input 11 to allow the user of the PUA 2 to input a message into the PUA 2. The message input 11 is coupled with the communication interface 9 of the PUA 2, so that a message inputted using the message input 11 can be communicated from the PUA 2 via communications 8. It is understood that messages inputted using the message input 11 may be communicated to the processor 5, or to another PUA 2, or to another location or device coupled with communications 8. In the illustrative embodiment shown in FIG. 1B, the message input 11 comprises a plurality of keys 11a in the form of a keypad. However, the configuration of the message input 11 may vary, such that, for example, the message input 11 may comprise one or more of a key, a button, a switch, a keyboard, a microphone, a video camera, a touch pad, an accelerometer, a motion detector, a touch screen, a tablet, a scroll-and-click wheel or the like.

In the illustrative configuration shown in FIG. 1B, the PUA 2 also comprises a sensor or a detector 13 for detecting one or more parameters. The parameter or parameters detected by the sensor/detector 13 include, but are not limited to, software installations on the PUA and/or activated applications, the remaining power capacity of the PUA 2, one or more of a user's biometric functions or parameters, a location of the PUA 2, a change in location of the PUA 2, data input to the PUA by the user, sounds external to the PUA 2, motion of the PUA 2, pressure being applied to the PUA 2, or an impact of the PUA 2 with another object. In certain embodiments, sensor/detector 13 detects a presence indication signal or a personal identification signal emitted by the PUA 2 or a signal emitter 14 carried in or on the person of the user. In certain ones of these embodiments, the signal emitter 14 comprises a device worn or carried by the user, such as an article of jewelry, a wristwatch, a key fob, and the like that are configured to emit a predetermined signal indicating a user's presence or the identity of the user wearing or carrying the device. The signal may be emitted as an acoustic signal, an RF or other electromagnetic signal, or a chemical signal that sensor/detector 13 is operative to receive, or an electrical signal (e.g., Bluetooth). In certain embodiments, the sensor/detector 13 includes a plurality of sensors or detectors each for detecting one or more of a plurality of parameters.

As shown in FIG. 1B, the sensor/detector 13 is coupled with the communications interface 9 of the PUA 2 so that data produced as a result of the sensing or detecting performed by the sensor/detector 13 can be communicated from the PUA 2 to the processor 5. Although the PUA 2 shown in FIG. 1B includes both the message input 11 and the sensor/detector 13, it is understood that in other embodiments, one of these elements may be omitted depending on the design of the PUA 2 and the requirements of the monitoring system 1.

As in FIG. 1A, the illustrative configuration of the monitoring system 1 shown in FIG. 1B includes storage 6 coupled or included with the processor 5 to store data, including data received and/or processed by the processor 5. Data stored in storage 6 can also be retrieved by the processor 5 when needed.

The PUA 2 shown in FIGS. 1A and 1B may be supplied with power from an A/C power source or other power supply, or using one or more batteries or other on-board power source (not shown for purposes of simplicity and clarity). It is understood that batteries used to supply power to the PUA 2 may include any type of batteries, whether rechargeable or not, that are suitable for use with the particular PUA 2. In certain embodiments, the PUA 2 receives power from rechargeable batteries or another kind of rechargeable power supply, such as a capacitor, and/or from a radiant energy converter, such as a photoelectric power converter, or a mechanical energy converter, such as a microelectric generator. In certain embodiments, the PUA 2 is connected with a docking station from time to time, which is used for charging the PUA 2 and/or transmitting data stored in the PUA 2 to the processor 5. FIG. 1C shows an embodiment of the PUA 2 used with a docking station 15. The docking station 15, which is typically not carried by the user and not coupled with the PUA 2 while the PUA is being carried by the user, is adapted to couple with the PUA 2 via a coupling 16. The coupling 16 can be a direct connection between the PUA 2 and the docking station 15 to allow recharging of the PUA 2 and/or communication of data between the PUA 2 and the docking station 15. In certain embodiments, data is communicated from the PUA to the docking station by a wireless infra-red, RF, capacitive or inductive link. In certain embodiments, data is communicated from the PUA 2 to the processor 5 by cellular telephone link or other wired or wireless network or device coupling.

As shown in FIG. 1C, in certain embodiments the docking station is connected to a power supply 17 to provide power for charging the PUA 2 when the PUA 2 is coupled with the docking station 15. In addition, in certain embodiments the docking station 15 includes a communication interface 19 adapted to communicate with the processor 5 through communications 7. When the PUA 2 is coupled with the docking station 15 via the coupling 16, data stored in the PUA 2, such as data collected by the PUA 2 when it was carried by the user, is transferred to the docking station 15 using the coupling 16 and thereafter communicated using the communication interface 19 to the processor 5 through communications 7. In these embodiments, the use of the docking station 15, rather than the PUA 2, to communicate to the processor 5 data collected by the PUA 2 enables conservation of power by the PUA 2 or the use of an internal power supply having a relatively low power capacity. In certain embodiments, the docking station 15 is also used to receive data from the processor 5 via communications 7, and to transfer the received data from the docking station 15 to the PUA 2 via the coupling 16 when the PUA 2 is coupled with the docking station 15.

As can be appreciated, the configuration of the docking station 15 is not limited to the configuration shown in FIG. 1C and may vary from one embodiment to another. For example, in certain embodiments, the docking station is used only for charging the PUA 2 and does not include a communication interface 19. In such embodiments, the docking station 15 is implemented variously as a cradle receiving the PUA 2 or as a standard AC-to DC converter, like a cellular telephone charger. In other embodiments, the docking station 15 is used only for communication of data between the PUA 2 and the processor 5 and does not charge the PUA 2. In such embodiments, the PUA 2 may be connected to a power supply, separate from the docking station 15, for charging, or charged using an internal power converter, or by replacing one or more batteries.

In certain embodiments, the PUA 2 shown in FIGS. 1A-1C optionally includes an output (not shown for purposes of simplicity and clarity) for outputting a message to the user. The output can be in the form of a display for displaying text, or one or more symbols and/or images, a speaker or earphone for outputting a voicemail or a voice message, or one or more LED's or lamps for indicating a message to the user. It is understood that the output or outputs are not limited to the examples provided herein and can comprise any suitable output or outputs adapted to provide a message to the user.

The monitoring system 1 shown in FIGS. 1A and 1B is used in certain embodiments for monitoring use by a user of the PUA 2 in accordance with at least one predetermined use criterion, namely, that the PUA 2 is being carried and/or used by a specific user. In certain embodiments, the monitoring system 1 is used to determine the identity of the user, whether or not a specific user, so that the data gathered by or with the use of the PUA 2 can be associated with the identity of the actual user. In certain embodiments, the monitoring system 1 monitors use of the PUA 2 in accordance with one or more of the following criteria: that the PUA 2 is being carried and/or used, that the PUA 2 is turned “on,” that the PUA has predetermined software installed or applications activated, that the PUA 2 is charged, that the PUA 2 maintains a minimum power capacity, that the PUA 2 is, or has been, docked at, or connected with, the docking station 15 for a predetermined length of time, at certain times or during a predetermined time period, that the PUA is functioning properly to provide a benefit to the user, and that the PUA 2 is capable of collecting, storing and/or communicating research data, or of cooperating with one or more other devices to do so. Other predetermined use criteria not mentioned above may also be employed in monitoring the PUA's use.

In certain embodiments, the method of monitoring use by a user of a research device such as PUA 2 in accordance with at least one predetermined use criterion comprises “active” monitoring that requires a specific action or input from a user on a device. Typically, the action is prompted by a request message requesting data of a predetermined type, or a response within a given time. Descriptions of various embodiments directed to active monitoring are described in U.S. patent application Ser. No. 11/776,940 and are incorporated by reference herein.

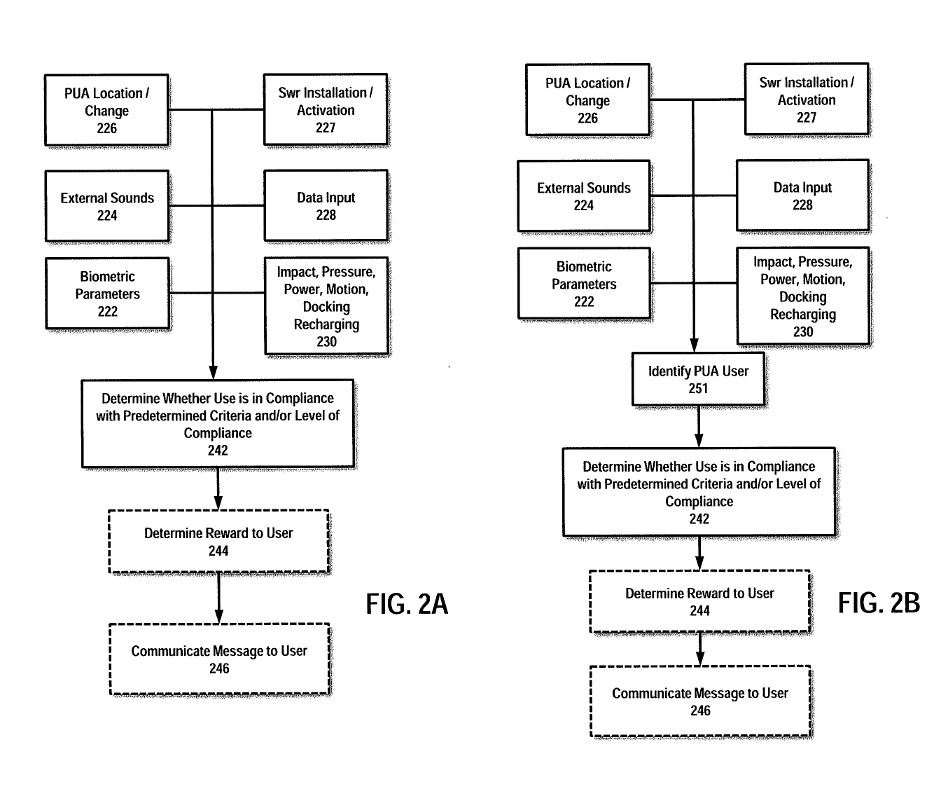

In certain embodiments of monitoring methods and systems, the monitoring system monitors one or more parameters, such as biometric parameters, sounds external to a research device, an impact of the research device with another object, motion of the research device, proximity of the research device to the person of a user, pressure applied to the research device, recharging of the research device, its power capacity, docking of the research device, data input (e.g., messages) to the research device, location of the research device and/or changes in the research device's location, to determine whether the use of the research device is in compliance with at least one predetermined criterion. In one illustrative embodiment, the monitoring system produces monitored data by monitoring at least one of a user's heart activity, a user's brain activity, a user's breathing activity, a user's pulse, a user's blood oxygenation, a user's borborygmus (gastrointestinal noise), a user's gait, a user's voice, a user's key, keypad or keyboard usage characteristics (e.g., keystroke recognition), a user's vascular pattern, a user's facial or ear patterns, a user's signature, a user's fingerprint, a user's handprint or hand geometry, a user's retinal or iris patterns, a user's airborne biochemical indicators (sometimes referred to as a user's “smellprint”), a user's muscular activity, a user's body temperature, sounds external to the research device, motion of the research device, pressure applied to the research device, recharging of the research device, docking of the research device, its power capacity, an impact of the research device with another object, data input to the research device by a user, location of the research device and a change in a location of the research device, and determines whether use of the research device by the user is in accordance with at least one predetermined criterion based on the monitored data. The operations of the monitoring system in these illustrative embodiments to monitor use of a PUA are shown in FIG. 2A. It will be appreciated that the embodiment of FIG. 2A is also applicable to a research device that is not a PUA.

As shown in FIG. 2A, at least one of a biometric parameter 222, proximity of the PUA to the person of a user, external sounds 224, PUA location, PUA location change 226, software installation/activation 227, data input 228 and impact of the PUA with another object, pressure applied to the PUA, power capacity, motion, recharging, docking 230 are monitored to produce monitored data. When one or more biometric parameters is monitored 222, these parameters include, but are not limited to, one or more of the user's heart activity, the user's brain activity, the user's breathing activity, the user's pulse, the user's blood oxygenation, the user's borborygmus, the user's gait, the user's key, keypad or keyboard usage characteristics, the user's voice, the user's fingerprint, the user's handprint or hand geometry, the user's retinal or iris patterns, the user's smellprint, a vascular pattern of the user, the user's facial or ear patterns, a pattern of muscle activity of the user, the user's signature, and the user's body temperature.

Referring again to FIG. 2B, the monitoring of the biometric parameters 222, external sounds, PUA location, PUA location changes 226, data input 228 and/or impact of the PUA with another object, pressure applied to the PUA, motion of the PUA, recharging, power capacity, docking 230 is performed in the PUA 2 by the sensor/detector 13 in cooperation with a processor of the PUA (not shown for purposes of simplicity and clarity). As mentioned above, the sensor/detector 13 in certain embodiments includes a plurality of sensors and/or detectors which monitor a plurality of parameters. In the embodiments in which the sensor/detector 13 monitors one or more biometric parameters of the PUA user 222, the sensor/detector 13 comprises one or more of a heart monitor for monitoring heart activity of the user, an EEG monitor for monitoring the user's brain activity, a breathing monitor for monitoring the user's breathing activity including, but not limited to, the user's breathing rate, a pulse rate monitor, a pulse oximeter, a sound detector for monitoring the user's borborygmus and/or the user's voice, a gait sensor and/or a gait analyzer for detecting data representing the user's gait, such as a motion sensor or accelerometer (which may also be used to monitor muscle activity), a video camera for use in detecting motion based on changes to its output image signal over time, a temperature sensor for monitoring the user's temperature, an electrode or electrodes for picking up EKG and/or EEG signals, and a fingerprint or handprint scanner for detecting the user's fingerprint or handprint. Where the user's retinal or iris patterns are monitored, sensor/detector 13 comprises a low-intensity light source, for scanning, detecting or otherwise sensing the retinal or iris patterns of the user. Where the user's hand geometry is detected, sensor/detector 13 comprises a device configured with an optical sensor or other imaging device to capture predetermined parameters of the user's hand, such as hand shape, finger length, finger thickness, finger curvature and/or any portion thereof. Where the user's smellprint is detected, sensor/detector 13 comprises an electronic sensor, a chemical sensor, and/or an electronic or chemical sensor configured as an array of chemical sensors, wherein each chemical sensor may detect a specific odorant or other biochemical indicator. Where a vascular pattern of the user is detected, sensor/detector 13 comprises an optical or other radiant energy scanning or imaging device for detecting a vascular pattern or other tissue structure, or blood flow or pressure characteristic of the user's hand or other body part. Where the user's facial or ear patterns are detected, the sensor/detector 13 comprises a video camera, optical scanner or other device sufficient to recognize one or more facial features or one or more features of the user's ear or other body part. In certain ones of these embodiments, the sensor/detector 13 is mounted in or on the PUA 2, while in others the sensor/detector 13 is arranged separately from the PUA 2 and communicates therewith via a cable or via an RF, inductive, acoustic, infrared or other wireless link.

In the embodiments in which the sensor/detector 13 of the PUA 2 monitors sounds external to the PUA 224, the sensor/detector 13 comprises an acoustic sensor such as a microphone or any other suitable sound detector for detecting external sounds. In certain embodiments, the sensor/detector 13, which monitors external sounds, cooperates with the processor for analyzing the detected external sounds. The external sounds detected by the sensor/detector 13 include, but are not limited to, environmental noise, rubbing of the PUA 2 against the user's clothing or other external objects, vehicle sounds (such as engine noise and sounds characteristic of opening and closing car doors), the user's voice print, dropping of the PUA, average ambient noise level, and the like.

In certain ones of the embodiments in which sensor/detector 13 monitors software installation/activation 227, the sensor/detector includes reporting software or application that monitor's the PUA's operating system and installations. Here, the PUA is monitored to determine that the proper and/or most up-to-date software is residing on the PUA. This embodiment is particularly advantageous where the PUA is capable of downloading software allowing it to report media exposure to audio and/or computer-related content (e.g., web pages, Internet media, text, etc.) as part of the research data.

In certain ones of the embodiments in which the sensor/detector 13 monitors the user's data input 228 (e.g., messages or inputs to control a diverse operation of the PUA, such as to make use of an application running thereon, like a game), the sensor/detector 13 comprises a pressure sensor for sensing pressure applied to the message input by the user. Alternatively or in addition, the sensor/detector 13 comprises a utility, such as a key logger, running on the processor of the PUA to determine and record its usage.

In the embodiments in which location change is being monitored 226, the sensor/detector 13 directly or indirectly detects the change in the PUA's location. Direct detection of the PUA's location is accomplished by detecting the location of the PUA and the change in PUA's location over time. In this case, the sensor/detector 13 comprises a satellite location system, such as a GPS receiver, an ultra wideband location detector, a cellular telephone location detector, an angle of arrival location detector, a time difference of arrival location detector, an enhanced signal strength location detector, a location fingerprinting location detector, an inertial location monitor, a short range location signal receiver or any other suitable location detector. The same means can also be employed to determine the PUA's location. Indirect detection of the PUA's location change is accomplished by detecting a predetermined parameter which is directly or indirectly related to the location of the PUA and determining from variations in the predetermined parameter whether a change in the location of the PUA has occurred. One of such predetermined parameters detected by the sensor/detector 13 can be variations in the strength of a RF signal received by the PUA, and in such case, the sensor/detector 13 comprises a RF signal receiver. Where location change data is available such data is used in certain embodiments to determine whether and when the PUA was or is being carried.

In embodiments in which the sensor/detector 13 monitors the impact of the PUA 2 with another object 230, the sensor/detector 13 comprises an impact detector for measuring pre-determined levels of impact of the PUA 2 with other objects. In certain embodiments, the sensor/detector 13 comprises an accelerometer for detecting a relatively large acceleration upon impact of the PUA 2 with another object. In embodiments where pressure applied to the PUA is monitored, a pressure sensor is placed on an enclosure of the PUA or mechanically coupled therewith to receive force applied to such enclosure. In certain ones of such embodiments, the magnitude of the pressure as it varies over time and/or with location on the enclosure are analyzed to determine if the PUA is being or was carried and/or the manner in which it was used and/or the event of non-use.

In certain embodiments where motion of the PUA is monitored, a video camera of the PUA is used as a motion sensor. In certain ones of such embodiments, changes in the image data provided at the output of the video camera (either the entire image or one or more portions thereof) are processed to determine movement or an extent of movement of the image over time to detect that the PUA is being moved about, either by translation or rotation. Techniques for producing motion vectors indicating motion of an image or an extent of such motion are well known in the art, and are used in certain embodiments herein to evaluate whether the PUA is moving and/or the extent of such movement. In certain ones of such embodiments, changes in the light intensity or color composition of the image data output by the video camera (either the entire image or one or more portions thereof) over time are used to detect motion of the PUA. In certain embodiments where motion of the PUA is monitored, a light sensitive device, such as a light sensitive diode of the PUA, is used as a motion sensor. Changes in the output of the light sensitive device over time that characterize movement serve to indicate that the PUA is being carried. Also, devices, such as an accelerometer may be used as a motion sensor.

In certain embodiments, the one or more parameters also include power remaining in the PUA, recharging of the PUA and/or the event of docking of the PUA by coupling the PUA with the docking station, for example, as illustrated in FIG. 1C. In such embodiments, the monitoring system produces monitored data by monitoring the power remaining in the PUA and/or by monitoring the docking of the PUA at the docking station. In the embodiments in which the docking of the PUA is monitored, the monitoring system monitors the length of time the PUA was coupled with the docking station, the time period during which the PUA was coupled with the docking station, a time at which the PUA is docked, a time at which the PUA was undocked, whether or not the PUA is coupled with the docking station and/or the length of time passed since the PUA was last docked at the docking station.

In certain embodiments, monitored data comprises data which can be used to confirm the identity of the PUA user. For example, if one or more biometric parameters of the user are monitored by the sensor/detector, the monitored data includes data indicating or relating to one or more of the user's heart rate or other heart activity or parameter, EEG, blood oxygenation, breathing rate or other breathing activity or parameter, borborygmus, gait, voice, voice analysis, key, keypad or keyboard usage characteristics, fingerprints, handprints, hand geometry, pulse, retinal or iris patterns, olfactory characteristics or other biochemical indicators, patterns of muscular activity, vascular patterns, facial or ear patterns, signature, and/or body temperature detected once or a plurality of times over a predetermined period of time. In certain embodiments, the user is identified by a signal from signal emitter 14. In another example, if the PUA location change is being monitored, then monitored data can include data relating to the specific locations or changes in location of the PUA and/or relating to the specific RF signal strengths of the PUA detected one or a plurality of times over a predetermined period of time.

Referring now back to FIG. 2A, the monitored data produced by monitoring at least one of a user's biometric parameters, external sounds, PUA location or location change, data input, pressure applied to the PUA, impact of a PUA with another object, a signal from signal emitter 14, PUA motion, PUA power level, recharging and docking of the PUA at the docking station is used to determine whether the user's use of the PUA is in compliance with the predetermined criteria and/or the user's level of compliance 242. In certain embodiments, the determination of compliance and/or level of compliance is performed in the PUA by its processor, while in other embodiments, the monitored data produced in the PUA is communicated to the processor 5 via its communications and the processor 5 then determines the user's compliance and/or level of compliance.

In certain embodiments, the determination of compliance and/or level of compliance is performed based on the detection or non-detection of one or more monitored parameters, as indicated by monitored data, to determine whether the PUA was carried and/or was charged at the monitoring times and/or whether the PUA was docked and/or undocked at predetermined times or time periods. In certain embodiments in which, as mentioned above, monitored data includes more specific or extensive data, the determination of compliance and/or level of compliance includes not only a determination whether the PUA was carried but also a confirmation that the PUA was carried by a specific user. In such embodiments, the compliance determination is performed by comparing the monitored data with pre-stored data relating to the specific user to determine whether the PUA was carried and whether the user carrying the PUA was the specific user. In particular, if the monitored data corresponds to the stored data for the specific user, then it is determined that the user carrying the PUA was the specific user. However, if the monitored data does not correspond to the stored data for the specific user, then it is determined that the user carrying the PUA was not the specific user. The determination whether the PUA use is in compliance with the predetermined criteria and/or the determination of the level of the user's compliance is then based on the determinations whether the PUA was carried and whether the user carrying the PUA was the specific user.

In certain embodiments, the PUA use is determined to be in compliance with the predetermined criteria if it is determined that the PUA was carried and/or used by the specific user and not in compliance if it is determined that the PUA was not carried. Depending on requirements of the monitoring systems and the predetermined criteria, in some embodiments the PUA use is determined to be in compliance, or in partial compliance, if it is determined that the PUA was carried by someone other than the specific user. However, in other embodiments, the monitoring system determines that the PUA use does not comply with the predetermined criteria if it is determined that the PUA was carried by someone other than the specific user.

With respect to the determination of the level of compliance, in certain embodiments, the highest level of compliance is determined if it is determined that the PUA was being carried by the specific user and the lowest level of compliance is determined if it is determined that the PUA was not carried. In certain embodiments, if the PUA was carried by someone other than the specific user at all or some of the monitoring times, then an intermediate level of compliance that is lower than the highest level and higher than the lowest level is determined The value of the intermediate compliance level may depend on whether the PUA was carried by someone other than the specific user at all or some of the times and the number of times that it is determined that the PUA was carried by someone other than the specific user, if a plurality of determinations are made.

As shown in FIG. 2A, the user of the PUA may optionally be rewarded for the user's compliance with the predetermined use criteria. As discussed above, providing a reward to the user in return for the compliant use of the PUA provides an incentive for the user to comply with the PUA use requirements in the future. In the embodiments where the monitoring system provides a reward to the user, the reward to the user is determined 244 after the determination of compliance and/or level of compliance 242 is made. The determination of the reward is based on whether the user has complied with the predetermined use criteria and/or based on the level of user's compliance, and can be performed in the PUA or in the processor. As mentioned above with respect to FIGS. 2A and 2B, the reward to the user can include cash, credit, points usable to make purchases, services or other benefit to the user.

As also shown in FIG. 2A, in certain embodiments, the monitoring system optionally communicates a message to the PUA user indicating compliance and/or level of compliance and/or a reward earned by the user 246. In these embodiments, the message can be in the form of a telephone call, a text message, a voice mail, a voice message, an image, an email, a web page, a paper notification or any other suitable indication to the user. In certain ones of such embodiments, a light is illuminated or blinks, or a sound is emitted (similar to a voice mail notification) at intervals (such as an interval from one to five minutes) to indicate compliance or non-compliance. Where the light or sound notification indicates non-compliance, its intensity and/or frequency increases over time to gain the user's attention. Referring now to FIG. 1B, if the determination of compliance, level of compliance and/or reward is performed by the processor of the PUA, the message indicating compliance, level of compliance and/or reward can be communicated to the user by the PUA. If, on the other hand, the determination of compliance, level of compliance and/or reward is performed by the processor 5, the message can be communicated to the PUA to provide the message to the user, or the message can be communicated to the user by another means.

As discussed above, the determination of a reward to the user 244 and the communication of a message to the user 246 are optional. Thus, it is understood that the monitoring system may perform both, none or only one of these actions, depending on the arrangement of the PUA and the requirements of the monitoring system.

In certain other embodiments, methods and systems for monitoring use by a user of a research device comprise producing monitored data by monitoring one or more parameters, producing identification data identifying the user based on the monitored data and determining, based on the identification data, whether the research device is being used by the user in accordance with at least one predetermined use criterion. FIG. 2B illustrates the actions performed by the monitoring system of this embodiment wherein the research device comprises a PUA, but it will be appreciated the monitoring system is also applicable to embodiments in which the research device does not comprise a PUA. In FIG. 2B, actions performed by the monitoring system similar to those illustrated in FIG. 2A are indicated by the same reference numbers as in FIG. 2A.

As shown in FIG. 2B, the monitoring system monitors at least one of a user's biometric parameter 222, external sounds, a presence indication signal, a personal identification signal 224, PUA location, PUA location change 226, software installation/activation 227, data input to the PUA 228 and impact of the PUA with another object, motion of the PUA, pressure applied to the PUA 230. As discussed herein above with respect to FIG. 2A and referring to FIG. 1B, the monitoring is performed by the sensor/detector 13 in the PUA 2, and as a result of this monitoring, monitored data relating to the parameters monitored is provided. In certain ones of these embodiments, the monitor stores one or more signatures, feature sets or other characteristic data of the panelist assigned to the PUA (and thus the person who should be its sole user) to which the monitored data is compared to determine if the data match. This comparison provides an indication whether the PUA in fact is being carried and/or used by the correct user. If, for example, the monitoring system monitors the sounds external to the PUA, the monitored data will include not only an indication that an external sound was detected, but also data relating to the sound that was detected, such as analysis of the detected sound, the frequency of the detected sound, voice identification data and/or other data relating to the detected sound, from which a sound signature or feature set can be produced for comparison against a stored signature or feature set to assess whether the PUA is in the possession of the correct user. In certain embodiments, the monitored data is used to determine whether the PUA is being carried. Thus, for example, if the monitoring system monitors the location change of the PUA, the monitored data will include data not only indicating a change in the PUA's location, it may be inferred that the monitor is in the possession of a user who is carrying it about.

Referring to FIG. 2B, the monitored data produced by monitoring one or more of the above-mentioned parameters may be used to provide identification data which is, in turn, used to identify the user of the PUA 251. In certain embodiments, the identification data is provided by the PUA and/or the docking station, while in other embodiments, the monitored data is communicated from the PUA to the processor 5 via the communications and the processor 5 provides the identification data based on the monitored data. In certain embodiments, the identification data is provided by comparing the monitored data with pre-stored data relating to at least one PUA user so as to determine the identity of the PUA user and/or to confirm that the PUA user is the specific user corresponding to the pre-stored data. The pre-stored data may be based on data relating to the PUA user obtained from the specific user in advance, or may be based on previously collected monitored data. By providing the identification data relating to the identity of the user, the monitoring system is adapted to confirm that a specific person, and not someone else, is carrying and/or using the PUA.

When the identification data is produced in 251, the monitoring system determines whether the use of the PUA is in compliance with at least one predetermined use criterion and/or the level of the user's compliance 242. This determination 242 is made based on the identification data identifying the user. In some embodiments, in which the identification data indicates that the person carrying and/or using the PUA is the corresponding, or correct, PUA user, the monitoring system determines in 242 that the PUA user has complied with at least one predetermined use criterion. The level of the user's compliance can be determined based on whether or not the PUA was carried and/or used in accordance with the predetermined criteria and based on whether or not identification data indicates that the person carrying and/or using the PUA matches the corresponding user for the PUA, as well as based on the frequency of compliant use indications. Thus, for example, a first level of compliance is determined if the identification data indicates that the PUA was carried by the user corresponding to the specific user for the PUA, a second level of compliance which is lower than the first level of compliance is determined if the identification data indicates that the PUA was carried by a user who does not correspond to the specific user of the PUA and a third level of compliance, which is lower than both the first and the second levels, is determined if the identification data indicates that the PUA was not carried by any user. It is understood that these compliance levels are illustrative and that the number of levels and how these levels are determined may vary.

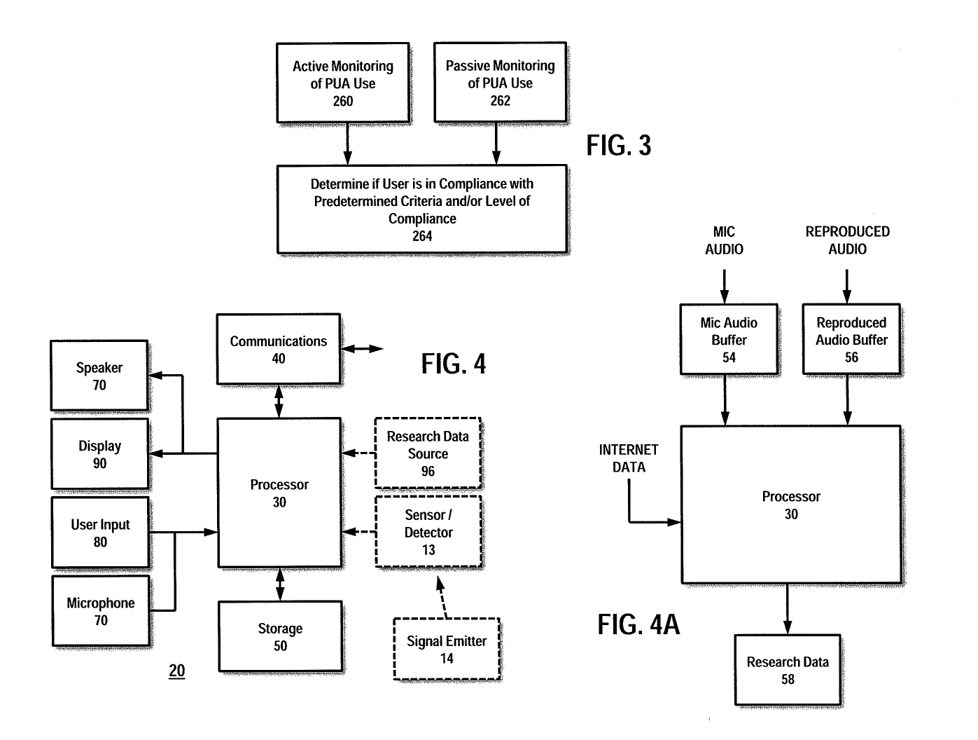

In certain embodiments described herein, the methods and systems for monitoring use of a research device in accordance with at least one predetermined use criterion comprise actively monitoring use of the research device by the user by communicating a message to the user requesting a response and passively monitoring use of the research device by the user by sensing at least one parameter indicating whether the research device is being used in accordance with the at least one predetermined criterion. FIG. 3 illustrates the actions performed by the monitoring system in these embodiments where the research device comprises a PUA. In other embodiments, the monitoring system monitors the use of a research device that does not comprise a PUA.

As shown in FIG. 3, the monitoring system actively and passively monitors the use of the PUA. Active monitoring 260 of the PUA use includes requesting an action by the user to show compliance with at least one predetermined use criterion and may comprise communicating a request message to the user requesting a response to the request message. Unlike active monitoring 260, passive monitoring 262 does not request any specific action to be performed by the user so as to indicate compliance with the PUA use criteria, and comprises sensing or detecting one or more parameters that indicate whether the PUA is being used in compliance with at least one predetermined criterion. Referring to FIG. 1B, the sensing or detecting is performed in the PUA 2 by the sensor/detector 13, and includes, but is not limited to, one or more of sensing a biometric parameter of the user, detecting a presence indication signal or a personal identification signal, sensing external sounds, detecting location of the PUA, detecting location change of the PUA, detecting motion of the PUA, detecting data input, sensing pressure applied to the PUA, detecting recharging, power capacity and/or docking of the PUA and detecting impact of the PUA with another object. These passive monitoring activities are similar to those described herein above with respect to FIGS. 3A and 3B, and therefore detailed description thereof is unnecessary.

In certain embodiments, the PUA carries out passive monitoring to produce passively monitored data, the monitoring system communicates a request message to the PUA, the PUA automatically produces a response including and/or based on the passively monitored data and communicates the response to the monitoring system and the monitoring system determines whether the use of the PUA complies with at least one predetermined use criterion based on the passively monitored data. In certain ones of such embodiments, the PUA communicates its response at a time when the PUA is to be used or carried in accordance with a predetermined schedule. In certain ones of such embodiments, the monitoring system communicates the request at a time when the PUA is to be used or carried in accordance with a predetermined schedule.

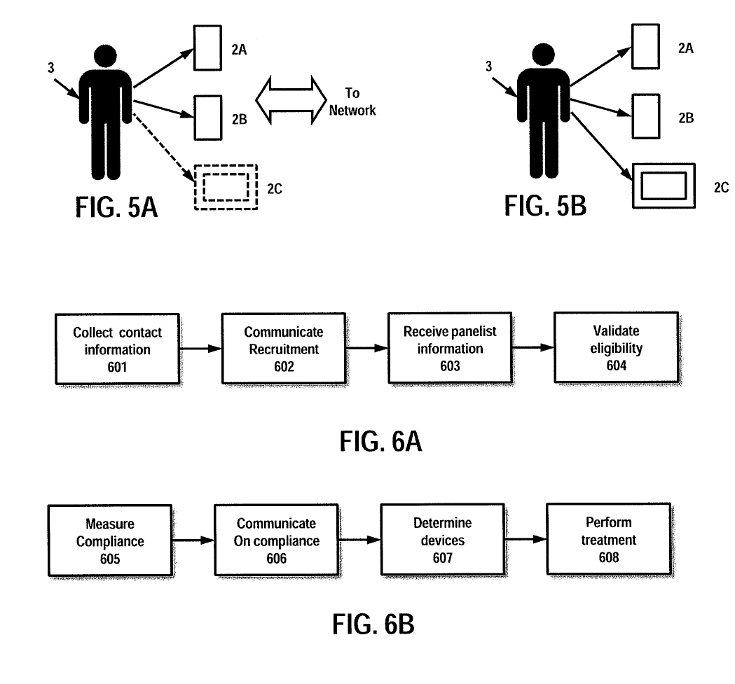

FIG. 4 is a block diagram of an exemplary PUA 20 embodied as a cell phone modified to carry out a research operation. The cellular telephone 20 comprises a processor 30 that is operative to exercise overall control and to process audio and other data for transmission or reception and communications 40 coupled to the processor 30 and operative under the control of processor 30 to perform those functions required for establishing and maintaining a two-way wireless communication link with a respective cell of a cellular telephone network. In certain embodiments, processor 30 also is operative to execute applications ancillary or unrelated to the conduct of cellular telephone communications, such as applications serving to download audio and/or video data to be reproduced by cellular telephone 20, e-mail clients and applications enabling the user to play games using the cellular telephone 20, and receive and/or execute other network data. In certain embodiments, processor 30 comprises two or more processing devices, such as a first processing device (such as a digital signal processor) that processes audio, and a second processing device that exercises overall control over operation of the cellular telephone 20. In certain embodiments, processor 30 employs a single processing device. In certain embodiments, some or all of the functions of processor 30 are implemented by hardwired circuitry.

Cellular telephone 20 further comprises storage 50 coupled with processor 30 and operative to store data as needed. In certain embodiments, storage 50 comprises a single storage device, while in others it comprises multiple storage devices. In certain embodiments, a single device implements certain functions of both processor 30 and storage 50. In addition, cellular telephone 20 comprises a microphone 60 coupled with processor 30 to transduce the audio to an electrical signal which it supplies to processor 30 for encoding or other purposes, and a speaker and/or earphone 70 coupled with processor 30 to convert received audio from processor 30 to an acoustic output to be heard by the user. Cellular telephone 20 also includes a user input 80 coupled with processor 30, such as a keypad, to enter telephone numbers and other control data, as well as a display 90 coupled with processor 30 to provide data visually to the user under the control of processor 30.

In certain embodiments, the cellular telephone 20 provides additional functions and/or comprises additional elements. In certain ones of such embodiments, the cellular telephone 20 provides e-mail, text messaging and/or web access through its wireless communications capabilities, providing access to media and other content. For example, Internet access by the cellular telephone 20 enables access to network data such as video and/or audio content that can be reproduced by the cellular telephone for the user, such as songs, video on demand, video clips and streaming media. In certain embodiments, storage 50 stores software providing audio and/or video downloading and reproducing functionality, such as iPod™ software, enabling the user to reproduce audio and/or video content downloaded from a source, such as a personal computer via communications 40 or through Internet access via communications 40.

To enable cellular telephone 20 to gather research data, namely, data indicating exposure to network data and/or audio such as programs, music and advertisements, research software is installed in storage 50 to control processor 30 to gather such data and communicate it via communications 40 to a research organization. The research software in certain embodiments also controls processor 30 to store the data for subsequent communication

In certain embodiments, the research software controls the processor 30 to decode ancillary codes in the transduced audio from microphone 60 using one or more of the known techniques described hereinabove, and then to store and/or communicate the decoded data for use as research data indicating encoded audio to which the user was exposed. In certain embodiments, the research software or application controls the processor 30 to extract a signature from the transduced audio from microphone 60 using one or more of the known techniques identified hereinabove, and then to store and/or communicate the extracted signature data for use as research data to be matched with reference signatures representing known audio to detect the audio to which the user was exposed. In certain embodiments, the research software both decodes ancillary codes in the transduced audio and extracts signatures therefrom for identifying the audio to which the user was exposed. In certain embodiments, the research software controls the processor 30 to store samples of the transduced audio, either in compressed or uncompressed form for subsequent processing either to decode ancillary codes therein or to extract signatures therefrom. In certain ones of these embodiments, the compressed or uncompressed audio is communicated to a remote processor for decoding and/or signature extraction.

Where the cellular telephone 20 possesses functionality to download and/or reproduce presentation data, in certain embodiments, research data concerning the usage and/or exposure to such presentation data as well as audio data received acoustically by microphone 60, is gathered by cellular telephone 20 in accordance with the technique illustrated by the functional block diagram of FIG. 5A. Storage 50 of FIG. 5 implements an audio buffer 54 for audio data gathered with the use of microphone 60. In certain ones of these embodiments storage 50 implements a buffer 56 for presentation data downloaded and/or reproduced by cellular telephone 20 to which the user is exposed via speaker and/or earphone 70 or display 90, or by means of a device coupled with cellular telephone 20 to receive the data therefrom to present it to a user. In some of such embodiments, the reproduced data is obtained from downloaded data, such as songs, web pages or audio/video data (e.g., movies, television programs, video clips). In some of such embodiments, the reproduced data is provided from a device such as a broadcast or satellite radio receiver of the cellular telephone 20 (not shown for purposes of simplicity and clarity). In certain ones of these embodiments storage 50 implements a buffer 56 for metadata of presentation data reproduced by cellular telephone 20 to which the user is exposed via speaker and/or earphone 70 or display 90, or by means of a device coupled with cellular telephone 20 to receive the data therefrom to present it to a user. Such metadata can be, for example, a URL from which the presentation data was obtained, channel tuning data, program identification data, an identification of a prerecorded file from which the data was reproduced, or any data that identifies and/or characterizes the presentation data, or a source thereof. Where buffer 56 stores audio data, buffers 54 and 56 store their audio data (either in the time domain or the frequency domain) independently of one another. Where buffer 56 stores metadata of audio data, buffer 54 stores its audio data (either in the time domain or the frequency domain) and buffer 56 stores its metadata, each independently of the other.

Processor 30 separately produces research data 58 from the contents of each of buffers 54 and 56 which it stores in storage 50. In certain ones of these embodiments, one or both of buffers 54 and 56 is/are implemented as circular buffers storing a predetermined amount of audio data representing a most recent time interval thereof as received by microphone 60 and/or reproduced by speaker and/or earphone 70, or downloaded by cellular telephone 20 for reproduction by a different device coupled with cellular telephone 20. Processor 30 extracts signatures and/or decodes ancillary codes in the buffered audio data to produce research data. Where metadata is received in buffer 56, in certain embodiments the metadata is used, in whole or in part, as research data 58, or processed to produce research data 58. The research data is thus gathered representing exposure and/or usage of audio data by the user where audio data is received in acoustic form by the cellular telephone 20 and where presentation data is received in non-acoustic form (for example, as a cellular telephone communication, as an electrical signal via a cable from a personal computer or other device, as a broadcast or satellite signal or otherwise).

In certain embodiments, the cellular telephone 20 is provided with a research data source 96 coupled by a wired or wireless coupling with processor 30 for use in gathering further or alternative research data to be communicated to a research organization. In certain ones of these embodiments, the research data source 96 comprises a location data producing device or function providing data indicating a location of the cellular telephone 20. In certain embodiments, research data source 96 comprises one or more devices for receiving, sensing or detecting data useful in implementing one or more of the foregoing functions, other research data gathering functions and/or for producing data ancillary to functions of gathering, storing and/or communicating research data. Such devices include, but are not limited to, motion detectors, accelerometers, temperature detectors, proximity detectors, satellite positioning signal receivers, video cameras, image scanners using visible or infra-red light or other radiant energy, chemical sensors, digital writing tablets, blood flow sensors, pulse oximeters, pulse monitors, RFID readers, RF receivers, wireless networking transceivers, wireless device coupling transceivers, pressure detectors, deformation detectors, electric field sensors, magnetic field sensors, optical sensors, electrodes (such as EEG and/or EKG electrodes), audio sensors, and the like. In certain embodiments, such devices are supplied in cellular telephones to provide a user-beneficial function, so that their capabilities can also be employed to gather research data and/or to gather data indicating whether the panelist has complied with predetermined use criteria. Such devices include but are not limited to, microphones, video cameras and satellite positioning signal receivers. Other embodiments describing functions relating to signature recognition, voice recognition, image recognition, keyboard usage sensing, motion sensing and the like are disclosed in U.S. patent application Ser. No. 11/776,940 and are incorporated by reference herein.

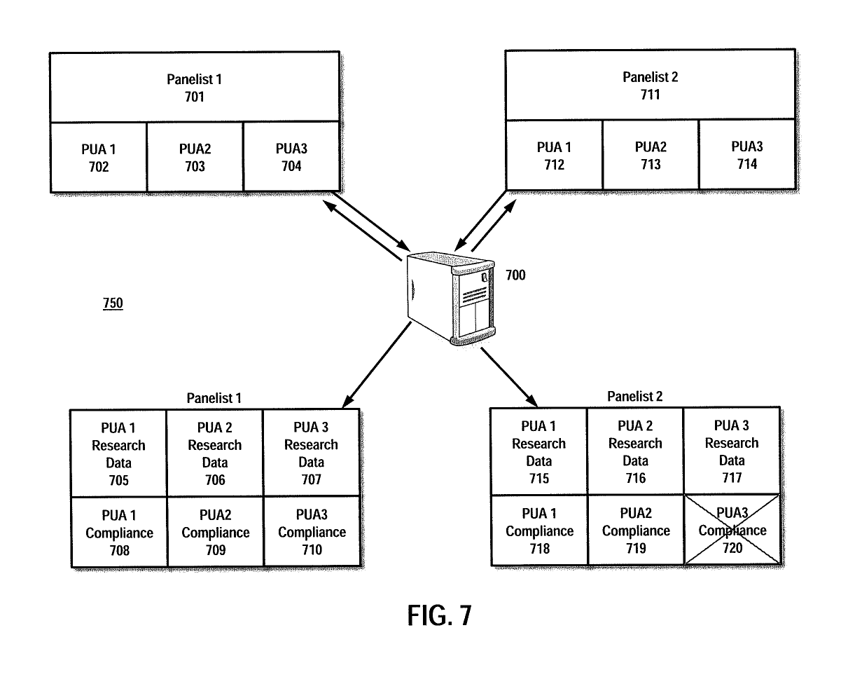

The techniques described above are also applicable to recruit, empanel and maintain panels for a research operation, particularly where a panelist is equipped with multiple PUA's. For example, a panelist may be equipped with a home computer, a cell phone, and a portable research device, such as a Portable People Meter (PPM™) developed by Arbitron Inc. To determine whether a panelist is intab or otherwise complying with predetermined use criteria, compliance measurement needs to be accomplished across multiple platforms. Under one exemplary embodiment illustrated in FIG. 6A, prospective panelists for a research operation are identified using conventional methods (e.g., email, telephone, etc.), and are contacted 501 to determine their willingness to participate in the research operation 602. Under a preferred embodiment, willing participants are selected 603 on the basis of having at least two PUA devices available, such as a home computer and a cell phone 605. Once selected, panelists are empanelled using a web interface, where information on the panelist, including demographic data, is obtained. After being empanelled, panelists are provided with an additional PUA (e.g., PPM 360) for measuring media exposure as part of the research data collection process.

Accordingly, the present example provides “3-screen” coverage for panelists in the research operation, where media exposure data may be measured from a panelist's PC, cell phone and a third PUA, such as a PPM™. Such coverage provides unprecedented depth in measuring media exposure across multiple platforms. During installation, panelists download first research software onto a home computer and second research software onto a smart phone. The first research software is configured to measure items such as web activity, email, etc., as well as detect ancillary codes and/or audio signatures from media. The second research software is similar to the first research software, but additionally measures smart phone-based usage, such as texting, contact lists, mobile app usage, movement, communications, calendar(s) and the like. It is understood that the first and second software may be (1) the same software producing the same research data, (2) the same software producing at least some different research data, (3) different software (i.e., based on different operating system platform) producing the same research data, and (4) different software producing at least some different research data. Exemplary systems and software are disclose in U.S. patent application Ser. No. 12/478,502 titled “Measuring Exposure to Media Across Multiple Media Delivery Mechanisms” to Monighetti et al., filed Jun. 4, 2009, U.S. patent application Ser. No. 12/618,950, titled “Determining Relative Effectiveness of Media Content Items” to Klein et al., filed Nov. 16, 2009, U.S. patent application Ser. No. 12/576,184, titled “Detecting and Measuring Exposure to Media Content items” to Zito et al., filed Oct. 8, 2009. Additional systems and software are disclosed in U.S. patent application Ser. No. 13/001,492, titled “Mobile Terminal and Method for Providing Life Observations and a Related Server Arrangement and Method With Data Analysis, Distribution and Terminal Guiding” to Karjalainen et al., filed Mar. 9, 2009 and U.S. patent application Ser. No. 13/002,205, titled System and method for Behavioural and Contextual Data Analytics” to Verkasalo, filed Feb. 16, 2011. Each of these references is incorporated by reference in its entirety herein.

During a compliance process, illustrated in FIGS. 5A-B and FIG. 6B, each of the PUA's 2A (e.g., computer), 2B (e.g., smart phone) and 2C (e.g., PPM) affiliated with panelist 3 are monitored actively and/or passively to determine compliance 605. In this example, PUAs 2A and 2B of FIG. 5A are determined to be compliant, but PUA 2C (e.g., PPM) is not. In this case, compliance information is communicated 606 to a computer network, such as the Internet. Depending on the nature of non-compliance, different actions may be taken to bring specific PUAs into compliance (cf. FIG. 5A 2C, FIG. 5B, 2C). In the event PUA 2C is incorrectly installed or otherwise not operating within a predetermined use criteria, a determination may be made 607 to see which devices should be reporting compliance data. If it is determined that PUA 2C is properly registered with panelist 3, information regarding the compliance and/or correction thereof may be communicated to either or all of PUAs 2A-C. If no communication is detected from PUA 2C, then information regarding the compliance and/or correction thereof may be communicated to PUAs 2A and/or 2B. In this case, other devices may be used to alert panelist 3 that a specific device is not being operated within predetermined use criteria. It is understood by those skilled in the art that a multitude of variations are possible for detecting and communicating compliance among the PUAs as disclosed herein.

To ensure future compliance, treatments 608 may be optionally offered to panelists to ensure future compliance. The term “treatments,” as referred to herein, relate to monetary or other rewards (e.g., coupons, discounts, free access to content, etc.) that provide a benefit to the panelist. In one example, panelists may be offered rewards for weekly and/or monthly usage that is within predetermined use criteria. The rewards may be dependent on the use of one PUA, or may be increased for proper usage of a plurality of PUAs. In another example, panelists may be rewarded for research software that is downloaded onto each PUA, and may be increased according to the type of PUA the software was downloaded to (e.g., computer, smart phone, etc.).

FIG. 7 illustrates an exemplary compliance system, where server 700 receives research data from a plurality of panelists, identified as “panelist 1” 701 and “panelist 2” 711 in the example. It should be understood that, while only two panelists are discussed in connection with FIG. 7, multitudes of panelists may be processed using the techniques described herein. Additionally, multiple servers may be used for the processing as well. Referring to FIG. 7, panelist 1 701 is associated with three PUAs (702-704), and panelist 2 702 is associated with three PUAs (712-714) as well. As each PUA collects research data, it also reports to server 700 compliance data. As the research data and compliance data is collected, server 700 processes this information and stores the accumulated research data and compliance data. In the example, panelist 1 is associated with research data 704-707 and compliance data 708-710 for each respective PUA. Similarly, panelist 2 is associated with research data 715-717 and compliance data 718-720 for each respective PUA.

In the example, the processing determines that panelist 1 has complied with predetermined usage criteria in 708-709 during a given research time period. Accordingly, panelist 1 may be offered treatments for the compliance, which may be communicated back to panelist 1 via server 700 of through other suitable means. For panelist 2, compliance data 718 and 719 was processed and determined that PUA 1 and PUA 2 were used in accordance with predetermined usage criteria. However, PUA 3 was determined to not be in compliance. The lack of compliance may be due to the PUA not being “on” for long enough durations, the software reporting back insufficiently small amounts of research data, the PUA research software being an incorrect version or type, or any of a number of reasons.

In this case, the research data provided by PUA 3 (717) may be discounted or discarded for the research time period, depending on the type and level of noncompliance. A message would then be transmitted to panelist 2, to any of PUAs 1-3, indicating the lack of compliance, and further requesting a response. Once the response is received, a further message would be transmitted to panelist 2, to any of PUAs 1-3, providing instructions or directions on corrective action panelist 2 should take. During the next research time period, each of the panelists is again processed to collect research data and compliance data. If, in this example, PUA 3 (714) for panelist 2 continues to be noncompliant, the research software and/or the PUA itself can be disabled, and the panelist may be contacted again for corrective action (i.e., replacement of PUA, reinstallation of software, etc.). Alternately, PUA 3 could be removed from consideration in the research data processing for the remainder of the research data gathering process, which in turn may result in a reduction in compensation panelist 2 receives for participation.

While at least one example embodiment has been presented in the foregoing detailed description, it should be appreciated that a vast number of variations exist. It should also be appreciated that the example embodiment or embodiments described herein are not intended to limit the scope, applicability, or configuration of the invention in any way. Rather, the foregoing detailed description will provide those skilled in the art with a convenient and edifying road map for implementing the described embodiment or embodiments. It should be understood that various changes can be made in the function and arrangement of elements without departing from the scope of the invention and the legal equivalents thereof.

What is claimed is:

1. A computer-implemented method for determining usage of a plurality of portable user appliances (PUAs), configured to detect media exposure and to produce PUA data, the method comprising the steps of:
receiving PUA data from each of the PUAs;
receiving research data from each of the PUAs, wherein the research data comprises media exposure data;
associating the research data with the PUA data; and
processing the PUA data to determine if each of the PUAs are in compliance with a predetermined usage criteria.

2. The computer-implemented method of claim 1, wherein the PUA comprises at least one of a smart phone, a laptop, a tablet computer, a personal computer, a portable people meter and a personal digital assistant.

3. The computer-implemented method of claim 2, wherein the plurality of PUAs are associated with a first panelist, and wherein each of the PUAs are different.

4. The computer-implemented method of claim 2, wherein a first plurality of PUAs are associated with a first panelist, and a second plurality of PUAs are associated with a second panelist.

5. The computer-implemented method of claim 1, wherein the PUA data comprises at least one of (i) data indicating a configuration of the PUA, (ii) data indicating a manner of usage of the PUA, and (iii) data indicating a state of the PUA.

6. The computer-implemented method of claim 1, wherein the research data comprises one of (i) ancillary codes detected from audio, (ii) audio signatures and (iii) metadata.

7. The computer-implemented method of claim 1, further comprising the step of providing a reward if at least one of the PUAs are determined to be within a predetermined usage criteria.

8. A system for determining usage of a plurality of portable user appliances (PUAs), comprising:
a first input for receiving PUA data detected from each of the PUAs;
a second input for receiving research data from each of the PUAs, wherein the research data comprises media exposure data; and
a processor, operatively coupled to the first and second input, wherein the processor associates the research data with the PUA data, and wherein the processor processes the PUA data to determine if each of the PUAs are in compliance with a predetermined usage criteria.

9. The system of claim 8, wherein each of the PUAs comprise at least one of a smart phone, a laptop, a tablet computer, a personal computer, a portable people meter and a personal digital assistant.

10. The system of claim 9, wherein the plurality of PUAs are associated with a first panelist, and wherein each of the PUAs are different.

11. The system of claim 9, wherein a first plurality of PUAs are associated with a first panelist, and a second plurality of PUAs are associated with a second panelist.

12. The system of claim 8, wherein the PUA data comprises at least one of (i) data indicating a configuration of the PUA, (ii) data indicating a manner of usage of the PUA, and (iii) data indicating a state of the PUA.

13. The system of claim 8, wherein the research data comprises one of (i) ancillary codes detected from audio, (ii) audio signatures and (iii) metadata.

14. The system of claim 8, wherein the processor determines a reward if at least one of the PUAs are determined to be within a predetermined usage criteria.
